(19) United States
(12) Patent Application Publication
(10) Pub. No.: US 2002/0006208 A1
(43) Pub. Date: Jan. 17, 2002

(54) Piezoelectric speaker

(76) Inventor: Toshitaka Takei, Fujisawa-shi (JP)

Correspondence Address: ZITO TLP, 26005 RIDGE ROAD, SUITE 203, DAMASCUS, MD, 20872, US

(21) Appl. No.: 09/894,959

(22) Filed: Jun. 28, 2001

(30) Foreign Application Priority Data
Jul. 13, 2000 (JP) 2000-212171

(51) Int. Cl. H04R 25/00

(52) U.S. Cl. 381/190; 381/191

(57) ABSTRACT

To provide a piezoelectric speaker in which a breakdown of an electric lead terminal is prevented when a large amount electric current flows into a thin narrow electrode lead terminal, any electric accident may be prevented in an electrode and a frame that would be likely to be touched by hands, the precision of position and shape of the electrode formed by using a mask is enhanced, and the generation of busy sound that becomes noise may be prevented at a predetermined frequency of the vibrating diaphragm, in the vibrating diaphragm, a side end of the vibrating diaphragm is clamped by wavy surfaces machined in at least one pair of plates to form a side frame the side frame is assembled with a vertical frame to form a frame, electrodes formed on the vibrating diaphragm are connected to each other by leads and the lead are fixed to the frame, whereby the vibrating diaphragm 1 may be firmly fixed to the side frame and concentration of electric current to local position of thin electrode lead terminals may be prevented.

### BACKGROUND OF THE INVENTION

The present invention relates to a piezoelectric speaker, and more particularly to a structure of a piezoelectric speaker in which a piezoelectric film is molded into an accordion shape to form a vibrating diaphragm, and alternating signals are inputted into electrodes formed on the vibrating diaphragm to thereby generate sound wave.

A conventional speaker such as a Heil speaker or a ribbon speaker in which a thin film is molded into an accordion shape and electrodes are formed to complete a vibrating diaphragm has been proposed. In the Heil speaker or ribbon speaker, both vertical ends that are not formed into a wavy shape in the vibrating diaphragm molded into the accordion shape are fixed to a frame when the vibrating diaphragm is to be fixed to the frame. Both side ends that are wavy are not fixed and kept free. Since the electrodes formed on each crest and trough of the vibrating diaphragm are connected in series, the flowing current is also caused to flow through the electrodes connected in series.

On the other hand, FIG. 1 is a perspective view of a conventional piezoelectric speaker. In the accordion shaped molded vibrating diaphragm 1, after the vertical ends 3-1 have been bonded to the vertical frames 2-1 and 2-2, the wavy side ends 4 are fixed to side frames 6-1 and 6-2 by adhesives 5. Also, electrode lead terminals 8-1 and 8-2 deposited on piezoelectric films 7-1 and 7-2 and external lead lines 9-1 and 9-2 are screw-fastened together to the vertical frames 2-1 and 2-2 of plastics by means of bolts 10-1 and 10-2. The acoustic signal current is inputted into the electrode lead terminals 8-1 and 8-2 from the external lead lines 9-1 and 9-2.

Accordingly, the current for driving the vibrating diaphragm 1 is inputted concentratedly from first ends of the narrow thin lead electrode terminals 8-1 and 8-2. However, since the electrodes 11 formed in the crests and troughs are connected in parallel, this system is different in electrode structure from the above-described Heil speaker or ribbon speaker.

Incidentally, although the above-described electrode lead terminals are to be explained with additional serial numbers to the numeral 8 as shown, the components having the like structure and the same function will be distinguished in accordance with the additional numbers added to the same reference numeral. However, if there would be no misunderstanding the representation of the numeral, only the main reference numeral will be used to collectively represent the components. This is the case also in other components that will be described hereunder. This rule will be applied to the components in the same manner.

However, since the above-described piezoelectric films 7 have a large static capacitance, if the frequency is increased, an impedance is lowered so that a large alternating current will flow. On the other hand, since the electrodes are manufactured by means of a thin coating method such as deposition, as shown in FIG. 1, all the signal applied to the electrodes is inputted from the electrode lead terminals 8-1 and 8-2 at first ends of the electrode leads 12-1 and 12-2 on the extension lines of the electrodes 11. For this reason, a large amount of current is caused to flow into the thin narrow electrode lead terminals 8-1 and 8-2. The electrode lead terminals 8-1 and 8-2 are evaporated to cause a breakdown of lines.

Also, as another problem, in order to generate a sufficient sound pressure in the piezoelectric speaker, the output voltage of an amplifier has to be further stepped up to apply a high voltage. Although it is not necessary to provide the voltage in the several kVs like a static speaker, since the peak voltage reaches about 100V even in the piezoelectric speaker, if the user's hand would touch the electrodes 11, the side frames 6-1 and 6-2, the vertical frames 2-1 and 2-2 and the like as shown in FIG. 1, there would be an electric accident.

Also, FIG. 2 is a plan view of a mask for manufacturing an electrode pattern. When the electrodes are to be formed on the piezoelectric film by means of deposition or etching or the like, the mask corresponding to the electrode pattern becomes necessary.

The mask pattern will now be described with reference to FIG. 2. As shown in FIG. 2, in the conventional mask, an electrode portion 14 indicated by blanks is removed from a thin iron plate 13 so that the insulating strip portion 15 is left as indicated by hatching. Since this insulating strip portion 15 is very thin at about 2 mm in width, it is likely to be bent and displaced laterally vertically. Accordingly, the electrode formed by using such a mask suffers from a problem that the precision of position or shape would become worse.

Also, the conventional structure in which the vibrating diaphragm 1 formed by the piezoelectric film into the accordion shape is fixed to the frame shown in FIG. 1 suffers from a problem that, if the sound pressure is somewhat increased, the vibrating diaphragm 1 is vibrated in universal directions to generate a busy sound at a predetermined frequency to generate noise.

### SUMMARY OF THE INVENTION

Accordingly, an object of the present invention is to provide a piezoelectric speaker in which a breakdown of an electric lead terminal is prevented when a large amount current is caused flow into a thin narrow electrode lead terminal, any electric accident may be prevented in an electrode and a frame that would be likely to be touched by hands, the precision of position and shape of the electrode formed by using a mask is enhanced, and the generation of busy sound that becomes noise may be prevented even at a predetermined frequency of the vibrating diaphragm.

In order to attain the above objects, according to the present invention, there is provided a structure of a piezoelectric speaker in which a piezoelectric films 7, 7-1, 7-2 are formed into an accordion shape to form a vibrating diaphragm 1 and an alternating signal is inputted into electrodes 11, 11-1, 11-2 formed on the vibrating diaphragm 1 to generate a sound wave, wherein in the vibrating diaphragm 1, side ends 4, 4-1, 4-2 of the vibrating diaphragm 1 are clamped by wavy surfaces machined in at least one pair of plates 19-1, 19-2 to form side frames 6, 6-1, 6-2, the side frames 6, 6-1, 6-2 are assembled with vertical frames 2, 2-1, 2-2 to form a frame, the electrodes 11, 11-1, 11-2 formed on the vibrating diaphragm 1 are connected to each other by leads 20 and the leads 20 are fixed to the frame.

According to this structure, the side ends 4, 4-1, 4-2 of the vibrating diaphragm 1 formed into a wavy shape are clamped by the pair of plates 19-1, 19-2 machined into a wavy shape in the same manner to form the side frames 6, 6-1, 6-2, and the electrodes 11, 11-1, 11-2 formed on the surface of the vibrating diaphragm 1 are connected at a plurality positions by the conductive leads 20 mounted on the side frames 6, 6-1, 6-2 to be taken outside.

Accordingly, it is possible to firmly fix the vibrating diaphragm 1 to the side frames 6 so that the current may be prevented from concentrating on a local position of the thin electrode lead terminals 8-1, 8-2.

In the piezoelectric speaker according to the present invention, the pair of plates 19-1 and 19-2 are made of conductive material.

With such a structure, it is possible to provide the electrical conductivity by clamping the electrodes 11, 11-1, 11-2 directly by the side frames 6, 6-1, 6-2 and press fitting them.

Accordingly, the side frames 6, 6-1, 6-2 may also serve as the leads 20.

Furthermore, in the piezoelectric speaker according to the present invention, at least surfaces of the pair of plates 19-1 and 19-2 are coated with insulative material.

Accordingly, even if the side frames 6, 6-1, 6-2 are made of not only insulative material such as plastics or the like but also the conductive material as in the second aspect of the invention, the surface thereof is coated with insulative material whereby it is possible to prevent any electrical accident even if the hand touches the side frame.

Also, in the piezoelectric speaker according to the present invention, the pair of plates 19-1 and 19-2 have projections 22 on at least one surface machined into a wavy shape.

According the above, the projections 22 are provided on one wavy surface out of the pair of the plates 19-1 and 19-2 constituting the side frames 6, 6-1, 6-2 and the projections 22 are caused to pass through the vibrating diaphragm 1 to engage with the other plate wavy shaped surface.

Accordingly, the vibrating diaphragm 1 may be firmly fixed to the side frames 6, 6-1, 6-2. In addition, in the case where the pair of plates 19-1 and 19-2 are made of conductive material, it is possible to provide the sufficient electrical connection between the electrodes 11, 11-1, 11-2 and the side frames 6, 6-1, 6-2.

Furthermore, in the piezoelectric speaker according to the present invention, in the vibrating diaphragm 1, the side ends 4, 4-1, 4-2 of the vibrating diaphragm 1 are fixed to the frame so as to project from the side frame 6, 6-1, 6-2, electrode leads 12, 12-1, 12-2 are formed in the projections 23, and the electrode leads 12, 12-1, 12-2 are connected by the leads 20.

With such an arrangement, the side ends 4, 4-1, 4-2 of the vibrating diaphragm 1 are fixed to the frame so that they project from the side frames 6, 6-1, 6-2 composed of the pair of clamping plates 19-1 and 19-2 and the electrode leads 12, 12-1, 12-2 formed on the projecting projections 23 are connected to the leads 20 connected to the side frames 6, 6-1, 6-2.

Accordingly, it is possible to readily connect the electrodes 11, 11-1, 11-2 and the leads 20 with each other without any adverse affect to the vibrating surface at the plurality of positions firmly.

In the piezoelectric speaker according to the present invention, a plurality of electrodes 11, 11-1, 11-2 are formed on the same surface of the vibrating diaphragm 1, electrodes 11, 11-1, 11-2 that are not in conductive communication with each other on the same surface are provided within the plurality of electrodes 11, 11-1, 11-2, and the electrodes 11, 11-1, 11-2 are electrically conductive by the lead 20.

According to the above-described arrangement, the pattern is made as shown in FIG. 3, instead of the insulative strip portion of the mask shown in FIG. 2, to thereby prevent the bends and displacement of the insulative portion. Then, the electrode leads 12, 12-1, 12-2 formed on the piezoelectric films 7, 7-1, 7-2 have disconnected portions on the midway and are not contiguous to the electrode lead terminals 8-1, 8-2. However, according to the invention of the first aspect, the respective electrodes 11, 11-1, 11-2 mounted on the side frames 6, 6-1, 6-2 are connected.

Accordingly, it is possible to enhance the positional precision of the electrodes 11, 11-1, 11-2 and to attain the prevention of the breakdown of the electrode lead terminals 8-1 and 8-2 at once.

Furthermore, in the piezoelectric speaker according to the present invention, partitioning plates 26, 26-1, 26-2 are inserted between the two side frames 6, 6-1, 6-2, a plurality of crests and troughs 16 of the vibrating diaphragm 1 are partitioned by the partitioning plates 26, 26-1, 26-2.

With such an arrangement, when the vibrating diaphragm 1 is vibrated while receiving the acoustic signal, the partitioning plates 26, 26-1, 26-2 are inserted between the two side frames 6, 6-1, 6-2 in order to prevent the lateral displacement or to prevent the resonance caused by the mutual affect of the unit (speaker unit in the piezoelectric speaker) of the crest and trough 16 of the adjacent sets.

Accordingly, it is possible to prevent the user's finger from touching the vibrating diaphragm 1 by the partitioning plates 26, 26-1, 26-2 to thereby serve as the sufficient countermeasure to the electrical accident together with the feature of the third aspect and to make it possible to solve the two different issues such as the electrical accident and the busy sound at once.

Also, in the piezoelectric speaker according to the present invention, the partitioning plates 26, 26-1, 26-2 are formed integrally with the side frames 6, 6-1, 6-2.

Accordingly, it is possible to enhance the arrangement precision of the partitioning plates 26, 26-1, 26-2, and at the same time to simplify the work for mounting the partitioning plates 26, 26-1, 26-2 to the frames to thereby make it possible to reduce the cost.

Then, in the piezoelectric speaker according to the present invention, the vibrating diaphragm 1 is fixed to the frame under the condition a tension is applied in a vertical direction.

With such an arrangement, the vibrating diaphragm 1 is fixed to the frame by drawing the vibrating diaphragm 1 in the vertical direction so that the vibrating diaphragm 1 is kept in tension in the vertical direction to fix to the frame.

Accordingly, it is possible to maintain the tension of the vibrating diaphragm 1 for a long period of time, and to readily assemble to prevent the generation of the busy sound.

Furthermore, in the piezoelectric speaker according to the present invention, the vertical frames 2, 2-1, 2-2 are formed to be longer than a vertical length of the vibrating diaphragm 1 located between the two side frames 6, 6-1, 6-2 and a vertical tension is applied to the vibrating diaphragm 1 when the vertical frames 2, 2-1, 2-2 are mounted on the side frames 6, 6-1, 6-2 to assemble the frame.

With such an arrangement, first of all, the vibrating diaphragm 1 is fixed to the side frames 6, 6-1, 6-2, and at this time, the vertical frames 2, 2-1, 2-2 that are longer than the length in the vertical direction of the vibrating diaphragm 1 between the pair of side frames 6, 6-1, 6-2 are inserted in between the side frames 6, 6-1, 6-2 so that the vibrating diaphragm 1 is fixed to the frame under the condition that the vertical tension is kept in the same manner as that of the ninth aspect.

Accordingly, in the same manner as in the ninth aspect, the vibrating diaphragm 1 is firmly fixed to the side frames 6, 6-1, 6-2 by the pair of plates 19-1, 19-2 whereby the manufacturing work is facilitated to prevent the generation of the busy sound.

### BRIEF DESCRIPTION OF THE DRAWINGS

FIG. 1 is a perspective view of a conventional piezoelectric speaker.

FIG. 2 is a plan view of a mask used for manufacturing the conventional electrode pattern.

FIG. 3 is a plan view of the mask for manufacturing the electrode pattern in accordance with the sixth embodiment of the invention.

FIG. 4 is a perspective view of the piezoelectric speaker according to the first to third embodiments of the invention.

FIG. 5 is a side elevational view of the side frame of the piezoelectric speaker in accordance with the fourth embodiment of the invention.

FIG. 6 is a perspective view of the piezoelectric speaker in accordance with the fifth embodiment of the invention.

FIG. 7 is a perspective view of the piezoelectric speaker in accordance with the seventh embodiment of the invention.

FIG. 8 is a perspective view of the partitioning plate in accordance with the eighth embodiment of the invention.

FIG. 9 is a view illustrative of the piezoelectric speaker and the manufacturing method of the piezoelectric speaker in accordance with the ninth embodiment of the invention.

FIG. 10 is a view illustrative of the piezoelectric speaker and the manufacturing method of the piezoelectric speaker in accordance with the tenth embodiment of the invention.

### DESCRIPTION OF THE PREFERRED EMBODIMENTS

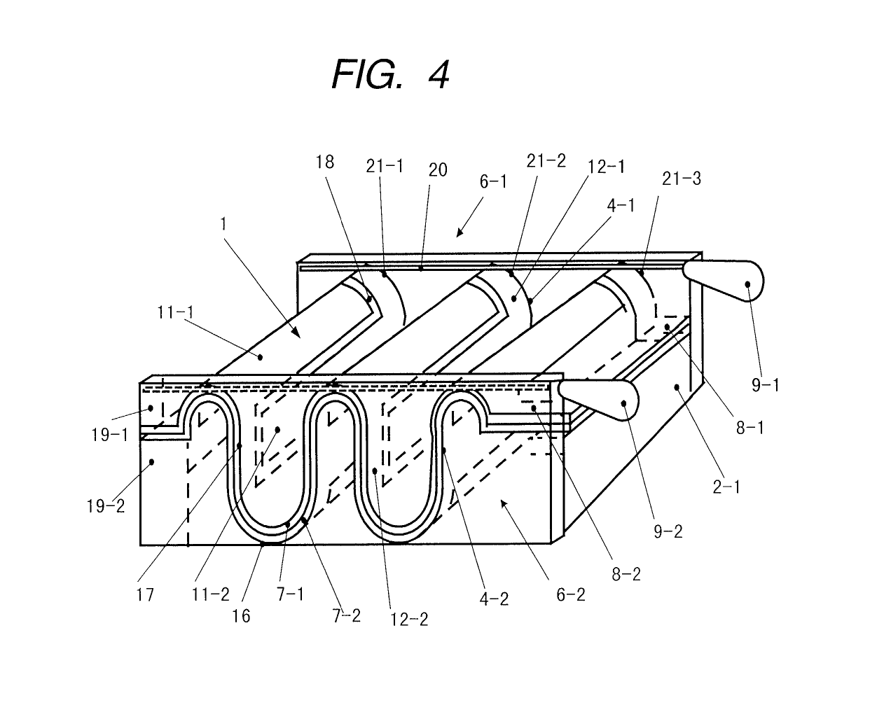

A first embodiment of the present invention will now be described with reference to the accompanying drawing, FIG. 4 which is a perspective view of a piezoelectric speaker for the first to third embodiments of the present invention.

As shown in FIG. 4, piezoelectric films 7-1 and 7-2 are bonded together to form a bimorph and a vibrating diaphragm 1 is molded into a accordion shape. Electrodes 11 are formed on crests and troughs 16 and walls 17 of the vibrating diaphragm 1 on the surface of the piezoelectric film 7 and electrode leads 12 are formed at side ends 4. Since the polarities are different from each other between the electrodes 11-1 of the crests and troughs 16 and the electrodes 11-2 of the walls 17 on the input side, the insulating strips 18 are provided.

Subsequently, the side ends 4 of the vibrating diaphragm 1 are surrounded by wavy surfaces formed into a pair of plates 19-1 and 19-2 in conformity with the wavy shape of the side ends 4. Leads 20 are fixed to side frames 6. The electrode leads 12 and the leads 20 are connected at a plurality of joint points 21 to each other by conductive paint or the like. Then, the leads 20 are connected to external lead lines 9-1 and 9-2.

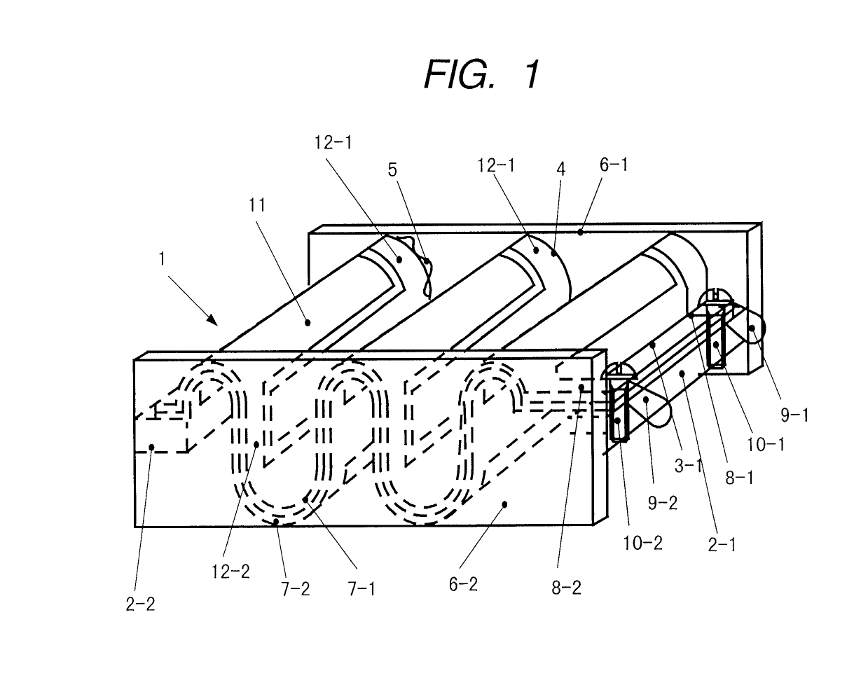

Conventionally, as shown in FIG. 1, the vibrating diaphragm 1 and the side frames 6 are fixed together by the adhesives 5 so that the acoustic signal current inputted from the external lead lines 9-1 and 9-2 into the electrode lead terminals 8-1 and 8-2 is fed to the electrodes 11 only through the electrode leads 12.

Since the electrode lead terminals 8-1 and 8-2 and the electrode leads 12 are thin metal films coated by means of the deposition or the like, if a large current is caused to flow, they would be like to be evaporated and broken down. Accordingly, if the electrodes 12 and the side frames 6 made of metal are connected by the conductive paint, the current is diffused and the probability of breakdown of lines is surely reduced.

However, since the adhesives 5 are projected between the electrode leads 12 and the side frames 6, the distance by which the connecting is carried out by the conductive paint is long. The electrode leads 12 and the side frame 6 are connected in a linear manner. Since the electrical conductivity of the conductive paint is not so good, there is a fear that the conductive paint is broken down or a spark would occur.

Therefore, as in the first embodiment, if the vibrating diaphragm 1 is clamped between the plates 19-1 and 19-2 and the vibrating diaphragm 1 is fixed to the side frames 6, there is no extra projection of the adhesives 5. Accordingly, the electrode leads 12 and the leads 20 may be connected at points of the joint points 21. Then, since the breakdown of the conductive paint no longer occurs and almost all current is caused to flow through the leads 20, there is no breakdown accident of the electrode leads 12 or the electrode lead terminals 8-1 and 8-2.

A second embodiment will now be described. In this embodiment, the side frames 6 shown in FIG. 4 are made of conductive material such as metal. Namely, the side frames 6 also serve as leads 20. In the same manner as in the first embodiment, the electrode leads 12 and the side frames 6 are connected by the conductive paint or the like.

Thus, since the side frames 6 also serve as the leads 20, the current is caused to flow directly through the side frames 6 from the external lead lines 9-1 and 9-2 to be introduced into the electrode 11. Therefore, there is no fear of the breakdown of the electrode lead terminals 8-1 and 8-2 or the like. Also, since the electrode leads 12 and the side frames 6 are connected at points of the joint points 21, it is also possible to prevent the breakdown of the conductive paint.

A third embodiment will now be described with reference to FIG. 4. First of all, the side frames 6 are made of insulative material such as plastics. Alternatively, in the case where the side frames 6 are made of conductive material such as metal, the top surface is coated with insulative material. In the case where the side frames 6 are made of insulative material, the leads 20 are fixed to the side frames 6, but after the fixture, the leads 20 are also coated with insulative material.

It is noted that, if the side frames 6 are made of conductive material as in the second embodiment, in the case where the user touches the side frame 6-1 by one hand and touches the side frame 6-2 by the other hand, the acoustic signal current stepped up by an amplifier or the like is caused to flow through the human body so that an electrical accident may be occurred. Therefore, the side frames 6 or the leads 20 having the conductivity are coated with insulative material to thereby prevent the electrical accident.

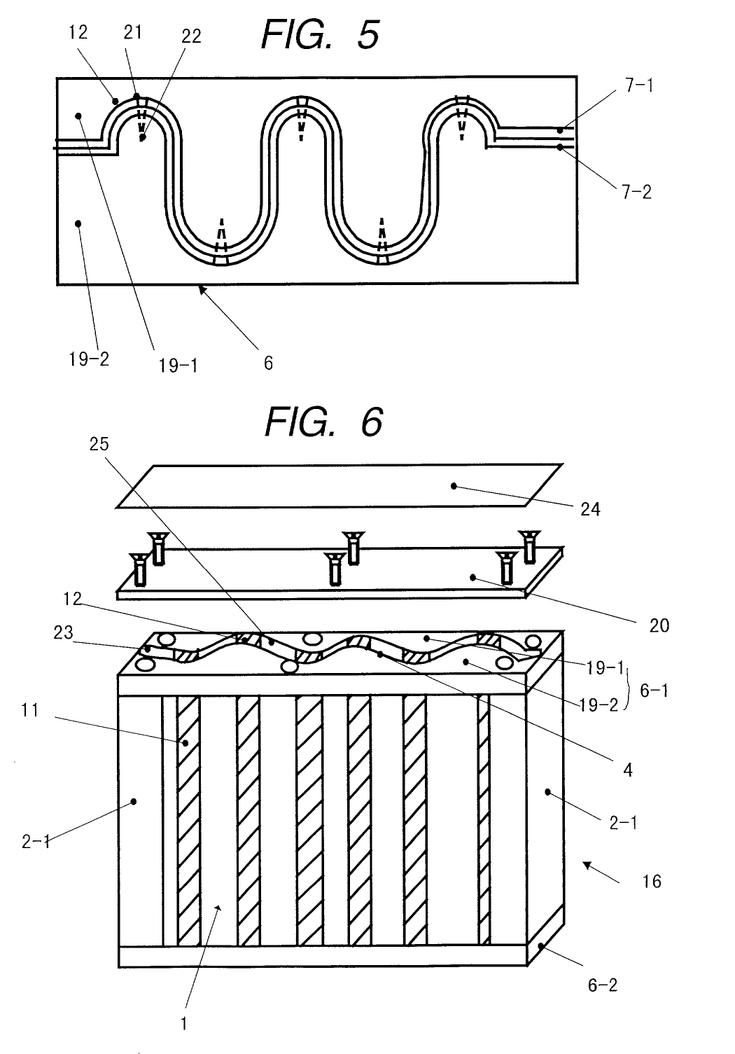

Next, in a fourth embodiment, as shown in a side elevational view of the side frame of FIG. 5, projections 22 are formed on a surface machined into a wavy shape in one plate 19-1 of the pair of plates 19-1 and 19-2. The projections 22 are firmly engaged with the other plate 19-2 on the opposite side passing through the electrode leads 12 formed in the piezoelectric films 7-1 and 7-2.

Thus, the projections 22 become joint points 21 for connecting the electrode leads 12 and the side frames 6 to thereby provide a firm electrical connection. Also, the surfaces, machined into wavy shape, of the pair of plates 19-1 and 19-2 are engaged with each other to form integral side frames 6 so that the vibrating diaphragm 1 is prevented from falling apart from the side frames 6.

Next, in a fifth embodiment, as shown in FIG. 6, the vibrating diaphragm 1 is clamped by the pair of plates 19-1 and 19-2 and fixed to the side frames 6. At this time, the side ends 4 of the vibrating diaphragm 1 forms projections 23 somewhat projecting from the side frames 6. Electrode leads 12 are formed on the projections 23. Then, the leads 20 made of a conductive plate are applied from above the projections 23 and screw fastened to the side frames 6.

Furthermore, insulative plates 24 are bonded from above the leads 20. Also, it is possible to bond a conductive tape as a lead 20 instead of the conductive plate or to apply conductive paint. Namely, if the projections 23 are made and the electrode leads 12 formed on the projections 23 are connected to the leads 20, the technical concept is the same.

Even if the pair of plates 19-1 and 19-2 are made of conductive material such as metal as in the second embodiment, unless the projections 22 shown in FIG. 5 is provided, it is not sufficient to provide the firm electrical connection between the side frames 6 and the electrode leads 12. Also, there is a fear that the vibrating diaphragm 1 would fall apart from the side frames 6.

Therefore, as shown in FIG. 6, the leads 20 are applied from above the projections 23, and the electrode leads 12 are press fitted to the side frames 6 and the leads 20, so that it is possible to prevent the vibrating diaphragm 1 from falling apart from the side frames 6 and it is also possible to obtain a sufficient electrical connection.

In the case where the side frames 6 are made of metal, it is possible to make the leads 20 of insulative material. In this case, the side frames 6 provide the electrical conductivity and serve as the leads 20. Also, in the case where the pair of plates 19-1 and 19-2 are made of insulative material, if the leads 20 are made of conductive material, it is possible to obtain a sufficient electrical conductivity. Furthermore, the insulative plates 24 are bonded to the side frames 6 to thereby eliminate a fear of electrical accident even if the hand touches the side frames 6.

Incidentally, although not shown in the drawings, in the case where the thus produced piezoelectric speaker unit is used to be embedded in the wall or the like, since it is possible to make a structure such that the hand or the like no longer touches the leads 20, it is unnecessary to particularly bond the insulative plates 24.

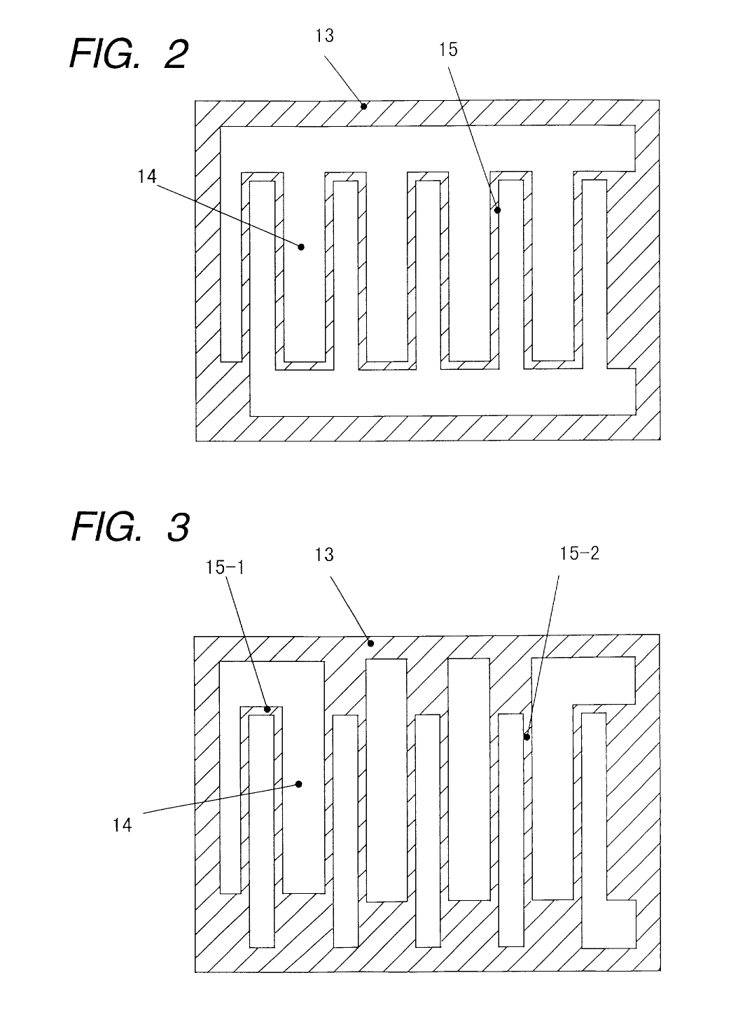

In a sixth embodiment, in order to enhance the precision of the mask, the mask shown in FIG. 3 is used. This mask is formed by removing the electrode portions 14 indicated by blanks for forming the electrodes 11 from the thin iron plate 13. Namely, thus, the insulative strip portions 15-1 and 15-2 or the like are left in the iron plate 13. Since the insulative strip portions 15-1 and 15-2 are not contiguous lice the insulative strip portions 15 of the conventional mask shown in FIG. 2, there is no fear of bends or displacement.

Accordingly, the electrode pattern manufactured by using the mask shown in FIG. 3 has a high precision. However disconnected portions 25 of the electrode leads 12 are generated as shown in FIG. 6. However, as described above, the projections 23 are press bonded by the leads 20 so that each of electrodes 11 is connected by the leads 20 and the joint points 21 (see FIG. 5). Thus, the fact that it is possible to obtain the sufficient electrical conductivity through the leads 20 to the external lead lines 9-1 and 9-2 is the same as in the fifth embodiment.

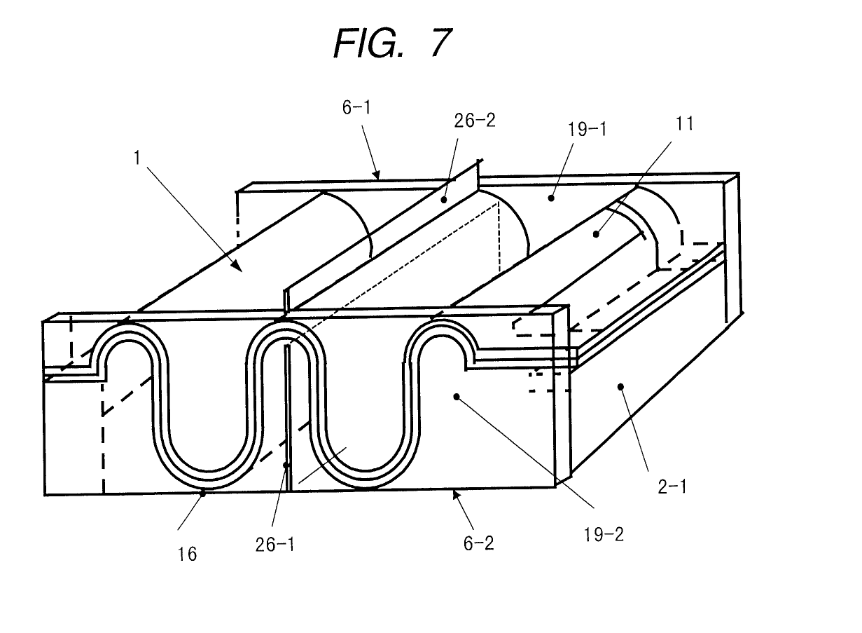

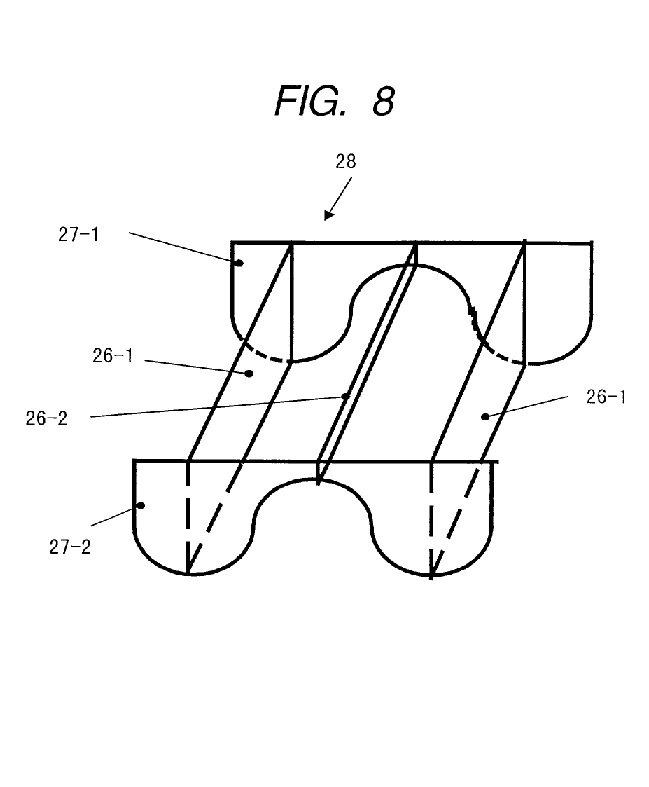

A seventh embodiment will now be described. As shown in FIG. 7, in this embodiment, partitioning plates 26-1 and 26-2 are inserted in a sound radiating surface in order to avoid the adverse affect of the vibration due to the operation and waves of the adjacent cell (a minimum unit of the accordion speaker unit obtained by dividing half the combination of the crest and trough 16) and in order not to move the apex points of the crests and troughs 16 formed by a continuous curved line by depressing with the partitioning plates 26-1 and 26-2 from both surfaces thereof. Namely, the partitioning plates 26-1 and 26-2 are inserted into both surfaces between the two side frames 6 in the vicinity of the apexes of the crests and troughs 16. Namely, the partitioning plates 26-1 and 26-2 are inserted in the direction for radiating the sound. It is most preferable to insert the partitioning plates 26-1 and 26-2 into every crest and trough 16. However, it is not always necessary to insert the partitioning plates 26-1 and 26-2 into every crest and trough 16. FIG. 7 typically shows the two partitioning plates 26-1 and 26-2.

If a number of partitioning plates 26 are arranged to be inserted into each crest 16 or trough 16, the distance between the adjacent partitioning plates 26 is narrow so that the finger could not be inserted therein. Accordingly, since the finger or the like no longer touches the electrode 11 of the vibrating diaphragm 1, it is possible to prevent the electrical accident. Also, the partitioning plates 26 become walls for preventing the adverse affect to the vibration of the adjacent crest and trough 16 to thereby make it possible to prevent the busy sound and to keep the sound pressure frequency characteristics in good condition. Namely, the piezoelectric speaker according to the present invention may radiate sound in the same manner either from a top side or a back side.

An eighth embodiment will now be described with reference to FIG. 8. In this embodiment, the partitioning plates 26 are formed integrally with the side frames 6. Alternatively, a partitioning plate assembly 28 forming the partitioning plates integrally to the side plates 27-1 and 27-2 in conformity with the side frames 6 is inserted between the two side frames 6.

The effect thereof is the same as that of the seventh embodiment. In particular, the side plates 27-1 and 27-2 may be regarded as parts of the side frames 6 in this embodiment. Also, since the partitioning plates 26-1 and 26-2 and the side frames 6 or the side plates 27-1 and 27-2 are formed integrally, it is possible to reduce the number of manufacturing steps for inserting the partitioning plates 26-1 and 26-2 to thereby reduce the cost.

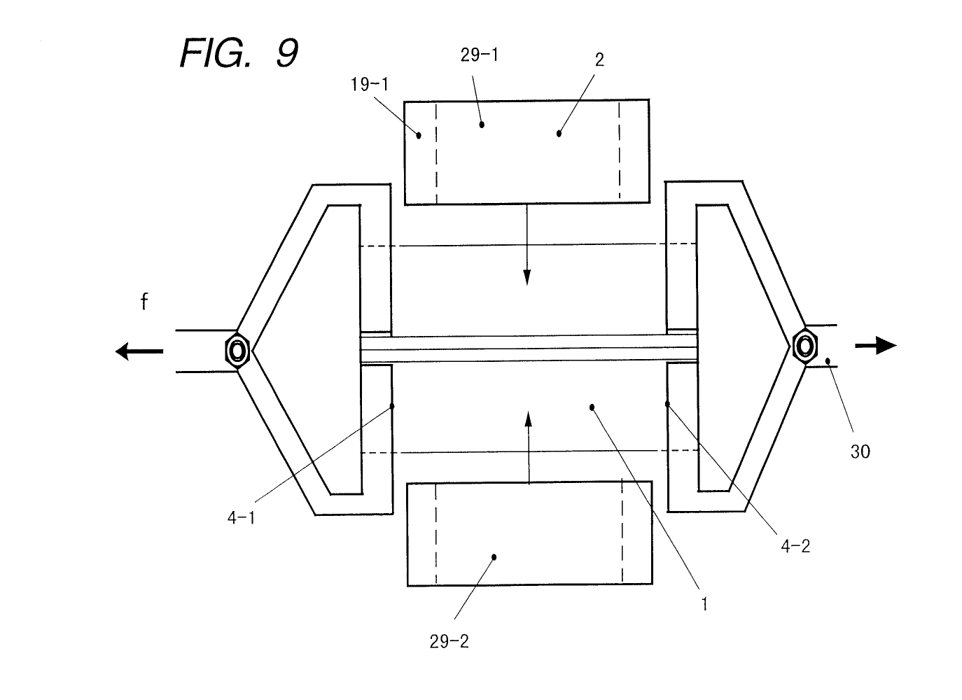

Subsequently, in a ninth embodiment, as shown in FIG. 9, the plates 19-1 and the vertical frame 2 are assembled in advance to form a frame plate 29-1. Subsequently, the side ends 4-1 and 4-2 of the vibrating diaphragm 1 are pulled by a force f in the vertical direction by means of a tensioning unit 30. It is preferable that the tension thereof causes the extension in the vertical direction about one percent. Then, the vibrating diaphragm 1 is clamped by the frame plates 29-1 and 29-2 from above and below and fixed thereto under the extended condition.

Accordingly, under the condition that the tension is applied to the vibrating diaphragm 1 in vertical direction, the vibrating diaphragm 1 is fixed to the frame constituted by the vertical frames 2 and the side frames 6. Thus, according to this embodiment, if the tension is applied to the vibrating diaphragm 1 in the vertical direction, it is confirmed that it is possible to reduce the busy sound that is noise generated from the vibrating plate 1. Then, according to a first aspect of the invention, it is possible to ensure the fixture of the vibrating diaphragm 1 to the side frames 6 under the condition that the tension is applied to the vibrating diaphragm 1 in the vertical direction for a long period of time.

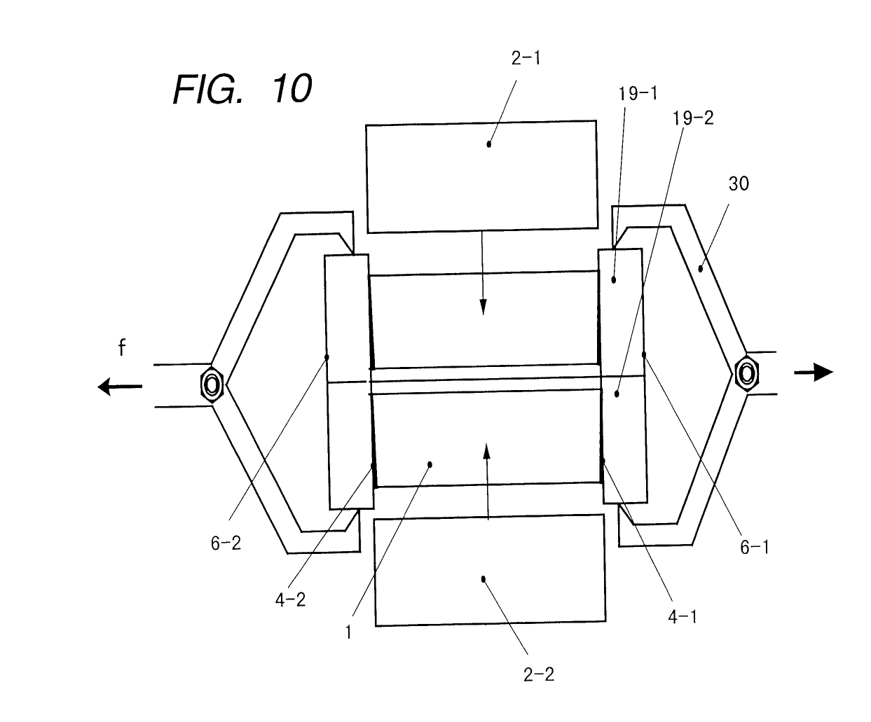

A tenth embodiment will now be described. As shown in FIG. 10, first of all, the side ends 4-1 and 4-2 are clamped by the pair of plates 19-1 and 19-2 and fixed to the two side frames 6-1 and 6-2. At this time, vertical frames 2-1 and 2-2 that are longer than a length between the two side frames 6-1 and 6-2 are prepared. Subsequently, the side frames 6-1 and 6-2 are clamped by the tensioning unit 30 and applied to the vibrating diaphragm 1 the force f in the vertical direction. It is preferable that this force causes a condition that the vertical extension of the vibrating diaphragm 1 is about one percent in the same manner as in the ninth embodiment. Then, if the vertical frames 2-1 and 2-2 are inserted between the two side frames 6-1 and 6-2 and assembled, under the condition the vertical tension is applied for a long period time, it is possible to firmly fix the vibrating diaphragm 1 to the side frames 6-1 and 6-2 according to a first aspect of the invention. This is the same as that of the ninth embodiment.

The effect or advantage of the present invention will now be described.

As described above in detail, according to the first aspect of the invention, the side ends of wavy shape are clamped by means of a pair of plates so that the vibrating diaphragm may be firmly fixed to the side frames. Also, it is possible to prevent the current from being concentrated onto the local position of the thin electrode lead terminals.

According to the second embodiment of the invention, since the side frames may also serve as the leads to thereby eliminate the breakdown of the electrode leads.

According to the third aspect of the invention, even if the side frames are made of not only insulative material such as plastics or the like but also the conductive material as in the second aspect of the invention, the surfaces thereof are coated with insulative material whereby it is possible to prevent any electrical accident even if the hand touches the side frames.

According to the fourth aspect of the invention, the vibrating diaphragm may be firmly fixed to the side frames. In addition, in the case where the plates are made of conductive material, it is possible to provide the sufficient electrical connection between the electrodes and the side frames.

According to the fifth aspect of the invention, it is possible to connect the electrodes and the leads at the plurality of positions with ease and without fail while not imparting the adverse affect to the vibrating surface.

According to the sixth aspect of the invention, it is possible to enhance the positional precision of the electrodes and to prevent the breakdown of the electrode lead terminals at once.

According to the seventh aspect of the invention, since it is possible to avoid the adverse affect of the vibration due to the operation and sound wave of the adjacent cell and to prevent the finger from touching the vibrating diaphragm because of the insertion of the partition plates, this is a sufficient countermeasure to the electrical accident as that of the feature of the third aspect and thus it is possible to solve at once the two problems of the prevention of the electrical accident and the prevention of the busy sound.

According to the eighth aspect of the invention, it is possible to enhance the arrangement precision of the partition plates and at the same time to reduce the cost since the work for mounting the partitioning plates to the frames may readily be performed.

According to the ninth aspect of the invention, it is possible to keep the tension of the vibrating diaphragm for a long period of time and at the same time to readily assemble it to thereby prevent the generation of the busy sound.

According to the tenth aspect of the invention, in the same manner as in the ninth aspect, since the vibrating diaphragm is firmly fixed to the side frames by the pair of plates to thereby facilitate the manufacturing work and to prevent the generation of the busy sound.

What is claimed is:

1. A structure of a piezoelectric speaker in which piezoelectric film 7, 7-1, 7-2 are molded into an accordion shape to form a vibrating diaphragm 1 and an alternating signal is inputted into electrodes 11, 11-1, 11-2 formed on the vibrating diaphragm 1 to generate a sound wave,
wherein in the vibrating diaphragm 1, side ends 4, 4-1, 4-2 of the vibrating diaphragm 1 are clamped by wavy surfaces machined in at least one pair of plates 19-1, 19-2 to form side frames 6, 6-1, 6-2, the side frames 6, 6-1, 6-2 are assembled with vertical frames 2, 2-1, 2-2 to form a frame, the electrodes 11, 11-1, 11-2 formed on the vibrating diaphragm 1 are connected to each other by leads 20 and the leads 20 are fixed to the frame.

2. The piezoelectric speaker according to claim 1 wherein the pair of plates 19-1 and 19-2 are made of conductive material.

3. The piezoelectric speaker according to claim 1 wherein at least surfaces of the pair of plates 19-1 and 19-2 are coated with insulative material.

4. The piezoelectric speaker according to claim 1 wherein the pair of plates 19-1 and 19-2 have projections 22 on at least one surface machined into a wavy shape.

5. The piezoelectric speaker according to claim 1 wherein in the vibrating diaphragm 1, the side ends 4, 4-1, 4-2 of the vibrating diaphragm 1 are fixed to the frame so as to project from the side frames 6, 6-1, 6-2, electrode leads 12, 12-1, 12-2 are formed in the projections 23, and the electrode leads 12, 12-1, 12-2 are connected by the leads 20.

6. The piezoelectric speaker according to claim 1 wherein in the vibrating diaphragm 1, a plurality of electrodes 11, 11-1, 11-2 are formed on the same surface of the vibrating diaphragm 1, electrodes 11, 11-1, 11-2 that are not in conductive communication with each other on the same surface are provided within the plurality of electrodes 11, 11-1, 11-2, and the electrodes 11, 11-1, 11-2 are electrically conductive by the leads 20.

7. The piezoelectric speaker according to claim 1 wherein partitioning plates 26, 26-1, 26-2 are inserted between the two side frames 6, 6-1, 6-2, a plurality of crests and troughs 16 of the vibrating diaphragm 1 are partitioned by the partitioning plates 26, 26-1, 26-2.

8. The piezoelectric speaker according to claim 1 wherein the partitioning plates 26, 26-1, 26-2 are formed integrally with the side frames 6, 6-1, 6-2.

9. The piezoelectric speaker according to claim 1 wherein the vibrating diaphragm 1 is fixed to the frame under the condition a tension is applied in a vertical direction.

10. The piezoelectric speaker according to claim 1 wherein the vertical frames 2, 2-1, 2-2 are formed to be longer than a vertical length of the vibrating diaphragm 1 located between the two side frames 6, 6-1, 6-2 and a vertical tension is applied to the vibrating diaphragm 1 when the vertical frames 2, 2-1, 2-2 are mounted on the side frames 6, 6-1, 6-2 to assemble the frame.
